(19) United States
(12) Patent Application Publication
(10) Pub. No.: US 2022/0384880 A1
(43) Pub. Date: Dec. 1, 2022

(54) A CARRIER FOR A BATTERY PACK

(71) Applicant: XEROTECH LIMITED, Oranmore, Galway (IE)

(72) Inventor: Barry FLANNERY, Oranmore, Galway (IE)

(21) Appl. No.: 17/769,736

(22) PCT Filed: Oct. 19, 2020
(86) PCT No.: PCT/EP2020/079409

§ 371 Date: Apr. 16, 2022

(30) Foreign Application Priority Data
Oct. 18, 2019 (GB) 1915161.2

(51) Int. Cl. H01M 10/6557; H01M 10/44; H01M 10/48; H01M 10/643; H01M 10/613; H01M 10/625

(52) U.S. Cl. CPC H01M 10/6557; H01M 10/443; H01M 10/482; H01M 10/486; H01M 10/643; H01M 10/613; H01M 10/625; H01M 2220/20

(57) ABSTRACT

A carrier means 1 for retaining and locating one or more sensing means 2,3 within a battery pack, the battery pack comprising one or more cells and a thermal management duct 10 in thermal contact with at least one cell, the carrier means 1 comprising a sensing means 2,3 for sensing one or more conditions of the battery pack and a connection means 4 for providing a communicative connection to the carrier means 1, wherein the sensing means 2,3 is operably connected to the connection means 4.

The present invention relates to a carrier for one or more electrical elements. In particular, the present invention relates to a carrier for use within a battery pack.

Safe and efficient use of a battery pack requires knowledge of the operating characteristics of the pack itself and the components therein. For example, when driving a hybrid or electric vehicle it is important to know the state of charge and the state of health of the battery pack, and ideally that of the individual cells. In larger packs employing e.g. lithium-ion cells, knowledge of the temperature characteristics of the pack is also important since cells are liable to overheating during the charge/discharge cycle. Furthermore, at low temperatures e.g. below 0° C. cell discharge performance is reduced while charging at such temperatures can result in lithium plating, causing significant irreparable damage and immediate capacity loss in the cell. Lithium plating and crystal formation within the cell can also puncture internal cell dielectric membranes, resulting in short circuits.

In order to keep battery pack cells within a suitable temperature envelope it is often necessary to provide a thermal management system which uses e.g. a pressurised thermal management fluid to transfer heat to/from the cells. To work effectively, the thermal management system relies on accurate measurements of e.g. temperature within the pack and pressure within the thermal management system. Furthermore, it is important to be able to accurately characterise and calibrate the thermal management system ducting manufacture of the pack, to ensure good performance.

A key manufacturing challenge of thermally managed battery packs relates to the incorporation of sensors and other electrical elements within the pack. Such assemblies incorporating multiple electrical elements often employ bundles of wires, complicating the manufacturing process and taking up significant amounts of space within the pack. Using large numbers of loose wires creates obvious challenges during automated high-volume manufacturing. Although it is possible to incorporate sensors into e.g. laminated bus bars instead of deeper within the pack, such a solution will not provide accurate measurements of cell temperature as bus bar heating can skew the measurement, and does not allow the manufacturer to accurately characterise and calibrate the thermal management system during manufacture of the pack.

It is an object of the invention to obviate or mitigate the problems outlined above. In particular it is an object of the invention to provide a way of incorporating one or more electrical elements in a battery pack.

It is a further object of the invention to provide one or more electrical elements that can be used to measure operating characteristics and/or manage components of a battery pack.

It is a further object of the invention to provide a way to characterise, calibrate and control the properties of a thermal management system within a battery pack.

It is a further object of the invention to provide electrical elements that can be installed within a battery pack during high volume automated assembly of the pack.

It is a further object of the invention to save space within a battery pack.

According to a first aspect of the invention there is provided a carrier means for retaining and locating one or more electrical elements within a battery pack, the battery pack comprising one or more cells and a thermal management duct in thermal contact with at least one cell, the carrier means comprising at least one electrical element for performing at least one battery pack function and a connection means for providing a communicative connection to the carrier means, wherein the electrical element is operably connected to the connection means. Advantageously the carrier means can be used to locate electrical element(s) within the battery pack without the need for large bundles of connectors thereby saving space within the pack. Beneficially, the connection means provides a way of connecting the carrier means to one or more external components such as a control computer.

By electrical element it is meant any suitable active or passive electrical and/or electronic component which can be used to perform a function such as sensing a parameter and/or conditioning cells within a battery pack.

By battery pack function it is meant any function that is performed during operation of the battery pack, for example measuring a property of a component of the battery pack, or discharging electrical current for cell balancing or thermal management purposes.

Preferably the carrier means is flexible. Advantageously, the provision of a flexible carrier means allows the carrier means, and therefore the electrical element(s), to be easily fitted within a battery pack.

Preferably the carrier means is a flexible printed circuit board (PCB).

Preferably the carrier means is a multilayer PCB.

Preferably the carrier means comprises a flexible substrate.

Preferably the substrate comprises a polyimide film.

Optionally the substrate comprises a polyester (PET) film.

Optionally the substrate comprises a glass fiber epoxy laminate.

Preferably the substrate comprises Kapton or FR-4.

Preferably the substrate comprises a base.

Optionally the substrate comprises a polyimine base.

Preferably the substrate comprises at least one cover layer.

Optionally the substrate comprises at least one polyimine cover layer.

Preferably the carrier means comprises a reinforcement means. Advantageously, the reinforcement means adds strength to the carrier means in certain locations where e.g. the carrier means may be subject to large forces.

Preferably the reinforcement means comprises polyimide, FR-1, FR-2, FR-4, CEM-1, CEM-3, RO3000 or RO4000.

Preferably the carrier means comprises at least one conductive pattern layer.

Preferably the or each conductive pattern layer is provided between a base layer and a cover layer.

Preferably adhesive layers are provided between the base layer(s), conductive pattern layer(s) and cover layer(s).

Preferably the conductive pattern layer comprises one or more conductive traces.

Preferably the conductive traces are 0.05-1 mm wide.

Ideally the conductive traces are copper traces.

Preferably the conductive traces include one or more signal lines.

Preferably the conductive traces include at least one ground line.

Ideally the carrier means comprises a common ground plane.

Preferably the common ground plane is provided by a conductive trace in the conductive pattern layer.

Preferably the carrier means comprises an electrical element in the form of at least one sensing means for sensing one or more conditions of the battery pack.

Ideally the sensing means is operably connected to the connection means via the conductive pattern layer.

Ideally the sensing means is electrically connected to the connection means via conductive traces in the conductive pattern layer.

Preferably the connection means is located proximal to a peripheral edge of the carrier means.

Preferably the connection means comprises one or more electrically conductive pads.

Preferably the or each electrically conductive pad is gold-plated.

Preferably the connection means comprise one or more edge connectors, solder pads, board-to-wire connectors, mezzanine connectors, 2-pin, 4-pin, 8-pin or 16-pin connectors, surface-mounted pins, connection blocks and/or terminals.

Preferably the sensing means comprises one or more sensors.

Preferably the sensing means comprises more than one type of sensor.

Preferably the sensing means comprises an array of sensors.

Preferably the sensing means comprises an array of regularly-spaced sensors.

Preferably the one or more sensors include any combination of temperature sensors, strain sensors, pressure sensors, volatile organic compound (VOC) sensors, carbon monoxide (CO) sensors, carbon dioxide (CO₂) sensors, smoke sensors, leak detectors, acceleration sensors, microelectromechanical systems (MEMS) sensors, state of health (SoH) sensors or state of charge (SoC) sensors.

Preferably the one or more sensors are surface mounted sensor(s).

Preferably the or each sensor is connected to at least one signal line in the conductive pattern layer.

Optionally the or each sensor is connected to a ground line in the conductive pattern layer.

Optionally a plurality of sensors are connected to a shared ground line in the conductive pattern layer.

Preferably the carrier means is an elongate carrier means.

Preferably the carrier means is 2-20 mm wide.

Preferably the carrier means is 5-10 mm wide.

Preferably the carrier means is 0.01-1 mm thick.

Preferably the carrier means extends in a longitudinal direction.

Ideally the carrier means is located within a battery pack.

Ideally the carrier means is located proximally to one or more cells.

Preferably the longitudinal direction of the carrier is perpendicular to the major axis of the cells.

Ideally the carrier means is located proximally to one or more ducts.

Preferably the carrier means is attachable to a duct.

Preferably the carrier means is adapted for operable connection to the thermal management duct.

Preferably the carrier means is adapted for thermal and/or mechanical connection to the thermal management duct.

Preferably the carrier means is attachable to a duct within a battery pack.

Preferably the duct is a thermal management duct.

Optionally the battery pack comprises a plurality of ducts.

Preferably the one or more ducts are serpentine ducts.

Optionally the one or more ducts are manifold ducts.

Optionally the battery pack comprises one or more substantially straight ducts.

Optionally the battery pack comprises one or more parallel ducts.

Preferably the or each duct comprises one or more substantially straight sections.

Preferably the or each duct is configured to carry a thermal management fluid.

Preferably the or each duct is configured to carry air, water or a water-glycol mixture.

Ideally at least part of the carrier means is attached to a duct along a portion of the length of the carrier means.

Preferably the carrier means is attached to a thermal management duct along at least a portion of the length of the carrier means.

Preferably the carrier means is locatable between the outer surface of the duct and one or more cells.

Ideally the carrier means is heat welded to the duct.

Preferably the carrier means is adhesively attached to the duct.

Preferably the carrier means is adhesively attached to the duct using an adhesive such as an epoxy.

Ideally the surface of the duct and/or the carrier means is treated with corona discharge plasma treatment. Advantageously, treating the surface and/or carrier in this way ensures good adhesion to the epoxy.

Optionally the carrier means is attached to the duct via mechanical fixation.

Preferably the carrier means comprises a mechanical fixation means.

Ideally the mechanical fixation means comprises one or more vias or through holes in the carrier.

Preferably at least a part of the duct passes through at least one via or through hole in the carrier to mechanically fix the carrier to the duct.

Preferably at least a part of the duct is melted through at least one via or through hole in the carrier.

Ideally the duct is a flexible duct.

Preferably the duct is inflatable.

Preferably the duct is conformable such that, in the inflated state, the duct at least partially conforms to at least part of the surface of one or more cells.

Preferably the flexible duct is formed from a polymer-based material.

Preferably the flexible duct is formed from an inflatable plastics material. An inflatable plastics material is advantageous as the material is intrinsically electrically insulating, lightweight and does not corrode or chemically interact with a thermal management fluid such as a glycol water mix.

Preferably the inflatable plastics material is polyester, low-density polyethylene (LDPE), linear low-density polyethylene (LLDPE) or high-density polyethylene (HDPE).

Ideally the walls of the flexible duct are between 10 μm and 150 μm thick. Advantageously, the inflatable plastics material may be made very thin which allows for good thermal transfer properties between the or each duct and the cells.

Optionally the duct is a rigid duct.

Optionally the duct is a metallic duct such as an aluminium or copper duct. Advantageously, a metallic duct provides good thermal conduction between the duct and the cells.

Preferably the duct is a single-lumen duct.

Optionally the duct is a multi-lumen duct. A multi-lumen duct may be used in large battery packs where a single lumen duct is not capable of promoting an even temperature distribution.

Ideally the multi-lumen duct comprises two or more lumens along which thermal management fluid may flow.

Preferably the carrier means is located within a battery pack

Ideally the battery pack comprises one or more cells.

Preferably the or each cell is a cylindrical cell.

Preferably the duct has an outer surface.

Preferably at least a part of the outer surface of the duct is in thermal contact with one or more cells. Advantageously, thermal contact between the duct and cells allows heat to be transferred to/from the cells for thermal management purposes.

Preferably at least a part of the outer surface of the duct is in physical contact with one or more cells.

Preferably the or each duct is inflatable.

Preferably the duct is filled with a thermal management fluid.

Preferably the or each duct is pressurised by the thermal management fluid to an inflated state.

Preferably the thermal management fluid is air, water or a water-glycol mixture.

Optionally the duct is filled with expandable foam such as intumescent or polyurethane foam.

Preferably the or each duct is pressurised by the expanded foam to an inflated state.

Preferably the or each duct, when in the inflated state, is in conformity with the surface of one or more cells.

Preferably the shape of the or each duct at least partially conforms to at least part of the surface of one or more cells.

Ideally the carrier means is located on the outer surface of the duct.

Ideally the carrier means is located between the outer surface of the duct and the one or more cells.

Preferably the or each sensor is located adjacent to at least one respective component to be measured.

Preferably the component(s) to be measured include at least the duct.

Preferably the component(s) to be measured include at least one cell.

Preferably the carrier means comprises one or more strain sensors for measuring strain on the duct. Advantageously, the strain sensors can provide an indication of the extension or flex of the duct when e.g. the duct is pressurised. Beneficially, strain sensors can be used to provide an indication of the level of pressure within the duct.

Preferably the carrier means comprises a plurality of strain sensors for measuring strain on the duct in a number of positions and/or directions.

Preferably the strain sensors are mounted on the surface of the carrier means adjacent to the duct.

Preferably the carrier means comprises one or more pressure sensors for measuring contact pressure between the duct and at least one cell. Advantageously, pressure sensors can be used to quantify how much contact pressure there is between the duct and a cell in order to characterise the amount of thermal coupling therebetween.

Preferably the sensing means comprises a plurality of pressure sensors for measuring contact pressure between the duct and a plurality of cells along the length of the duct.

Preferably one or more pressure sensors for measuring contact pressure of the duct on a cell are located between a cell and the duct.

Preferably the pressure sensors are piezoresistive pressure sensors.

Preferably the pressure sensors are MEMS pressure sensors.

Ideally the carrier means comprises one or more temperature sensors. Advantageously, temperature sensors are able to provide an indication of the temperature on or around the duct and/or one or more cells.

Ideally the carrier means comprises one or more temperature sensors for measuring the temperature of at least one cell.

Preferably the sensing means comprises a plurality of temperature sensors for measuring the temperature of a plurality of cells.

Ideally the carrier means comprises one or more temperature sensors for measuring temperature of the duct.

Ideally the carrier means comprises at least one temperature sensor located between the duct and a cell. Advantageously, in the inflated state the duct presses the temperature sensor against the cell to ensure good thermal contact between the duct and the cell.

Ideally the carrier means comprises at least one temperature sensor located on a surface of the carrier means adjacent to a cell.

Ideally the carrier means comprises a thermal barrier means.

Preferably thermal barrier means is located between the duct and the sensing means.

Ideally the thermal barrier means is located on the opposite side of the carrier means to a temperature sensor. Advantageously the thermal barrier means can be used to limit the thermal contact between a temperature sensor and a component that is not intended to be measured, e.g. the duct when the temperature sensor is being used to measure a cell.

Preferably the physical extent of the thermal barrier means is substantially equal to or greater than the area of the sensing means.

Preferably the thermal barrier means is located between at least one temperature sensor and the duct.

Ideally the carrier means comprises one or more leak sensors for measuring the presence of thermal management fluid on the external surface of the duct. Advantageously, leak sensors can provide an indication of leakage of thermal management fluid from within the duct.

Preferably the one or more sensors are individually addressable. Advantageously, making the sensors individually addressable provides an ability to resolve the distribution of measured parameters within the pack.

Preferably carrier means comprises an electrical element in the form of at least one energy dissipating means for dissipating energy from one or more cells.

Preferably the carrier means comprises a cell balancing means.

Preferably the energy dissipating means comprises a cell balancing means. Advantageously, the energy dissipating means can be used to dissipate excess charge within a cell in order to balance cell voltage in the pack.

Preferably the cell balancing means comprises one or more balancing resistors.

Preferably the or each balancing resistor is a conductive trace.

Preferably the or each balancing resistor is a copper trace.

Ideally the or each balancing resistor is a conductive trace within the conductive pattern layer.

Preferably the or each balancing resistor is a 0.05-0.2 mm wide conductive trace.

Preferably the or each balancing resistor is a 0.1-0.2 mm thick conductive trace.

Preferably the or each balancing resistor is a 100-10000 mm long conductive trace.

Preferably the or each balancing resistor is a conductive trace which follows a labyrinth path.

Preferably the or each balancing resistor is a conductive trace which follows a path comprising one or more straight sections and one or more bends or corners.

Alternatively the or each balancing resistor is a surface-mounted resistor.

Preferably the or each balancing resistor has a resistance of 1-100Ω.

Preferably the or each balancing resistor has a resistance of approximately 10Ω.

Preferably the energy dissipating means is operably connected to a switching means.

Preferably the switching means is connected to the energy dissipating means via the connection means.

Optionally the switching means is integrally connected to the carrier means.

Preferably the switching means comprises one or more solid-state switching means.

Preferably the switching means comprises one or more transistors.

Ideally the switching means is used to control discharge of energy from a cell through one or more balancing resistors.

Preferably the energy dissipating means is in thermal contact with the duct. Advantageously, the duct can be used to dissipate any heat generated in the energy dissipating means.

Preferably a measurement means is operably coupled to the sensing means via the electrical connection means.

Preferably the measurement means comprises one or more measurement circuits.

Preferably the measurement means comprises one or more Wheatstone bridge circuits.

Preferably the measurement means comprises a measurement computer.

Preferably the measurement computer is used to monitor one or more sensors.

Preferably the measurement computer is operable to output a signal when the measured value of at least one sensor is above a threshold.

Preferably the measurement computer is operable to output a signal when the measured value of at least one sensor is below a threshold.

Preferably the measurement computer is operable to output a signal when the measured value of at least one sensor is above a threshold.

Preferably the measurement computer is operable to output a signal when the measured value of at least one sensor is within a predetermined range.

Preferably the measurement means is coupled to the control circuit of the battery pack.

Preferably the operation of the battery pack is based on the output of the measurement means and/or the output of one or more sensors.

Preferably the control circuit is operable to cause the pressure within the duct to increase when the pressure within the duct, as measured by the one or more strain sensors, falls below a threshold.

Preferably the control circuit is operable to cause the flowrate of thermal management fluid within the duct to increase when the temperature of one or more cells, as measured by the one or more temperature sensors, is greater than a threshold.

Preferably the control circuit is operable to cause the pressure within the duct to increase when the contact pressure between the duct and one or more cells, as measured by the one or more pressure sensors, falls outside a predetermined range.

According to a second aspect of the invention there is provided a carrier means for retaining and locating one or more energy dissipating means within a battery pack, the battery pack comprising one or more cells and a thermal management duct, the carrier means comprising an energy dissipating means for dissipating energy from one or more cells wherein the energy dissipating means is in thermal contact with the thermal management duct. Advantageously, the energy dissipating means can be used to dissipate excess energy from a cell in order to balance cell voltage in the pack.

Preferably the energy dissipating means comprises a cell balancing means.

Preferably the cell balancing means comprises one or more balancing resistors.

Preferably the or each balancing resistor is a conductive trace.

Preferably the or each balancing resistor is a copper trace.

Ideally the or each balancing resistor is a conductive trace within the conductive pattern layer.

Preferably the or each balancing resistor is a 0.05-0.2 mm wide conductive trace.

Preferably the or each balancing resistor is a 0.1-0.2 mm thick conductive trace.

Preferably the or each balancing resistor is a 100-10000 mm long conductive trace.

Preferably the or each balancing resistor is a conductive trace which follows a labyrinth path.

Preferably the or each balancing resistor is a conductive trace which follows a path comprising one or more straight sections and one or more bends.

Alternatively the or each balancing resistor is a surface-mounted resistor.

Preferably the or each balancing resistor has a resistance of 1-100Ω.

Preferably the or each balancing resistor has a resistance of approximately 10Ω.

Preferably the energy dissipating means is operably connected to a switching means.

Preferably the switching means is connected to the energy dissipating means via the connection means.

Optionally the switching means is integrally connected to the carrier means.

Preferably the switching means comprises one or more solid-state switching means.

Preferably the switching means comprises one or more transistors.

Ideally the switching means is used to control discharge of energy from a cell through one or more balancing resistors.

According to a third aspect of the invention there is provided a carrier means for retaining and locating one or more functional elements within a battery pack, the battery pack comprising one or more cells and a thermal management duct in thermal contact with at least one cell, the carrier means comprising at least one functional element for performing at least one function within the battery pack and a connection means for providing a communicative connection to the carrier means, wherein the functional element is operably connected to the connection means.

By functional element it is meant any optical and/or electrical/electronic component which can be used to perform a function within the battery pack, for example a fiber bragg grating.

Preferably the connection means is an optical fiber.

According to a fourth aspect of the invention there is provided a method of manufacturing a battery pack comprising one or more cells, at least one flexible duct and a carrier means, the method comprising operably coupling the carrier means to the duct, inflating the duct and monitoring the output of an electrical element. Advantageously, the carrier means can provide real-time feedback to ensure that the duct is being correctly inflated.

According to a fifth aspect of the invention there is provided a method of manufacturing a battery pack comprising one or more cells and at least one flexible duct, the method comprising operably coupling at least one sensor to the duct, inflating the duct and monitoring the output of the sensor. Advantageously, monitoring the sensor can provide real-time feedback to ensure that the duct is being correctly inflated.

Preferably the method comprises operably connecting a plurality of sensors to the duct.

Preferably the method comprises operably connecting a carrier means to the duct, wherein the carrier means comprises an electrical element and a connection means.

Preferably the method comprises operably connecting a carrier means to the duct, wherein the carrier means comprises a sensing means and a connection means.

Preferably the method comprises operably connecting one or more strain sensors to the duct.

Preferably the method comprises operably connecting one or more temperature sensors to the duct.

Preferably the method comprises operably connecting one or more pressure sensors to the duct.

Preferably the method comprises inflating the duct when the duct is located adjacent to or between one or more cells.

Preferably the method comprises inflating the duct using a thermal management fluid such as air, water or a water-glycol mixture.

Preferably the method comprises inflating the duct using an expandable foam such as polyurethane foam or other intumescent foam.

Preferably the method comprises measuring strain on the surface of the duct using a strain sensor.

Preferably the method comprises measuring contact pressure between the duct and a cell using a pressure sensor.

Preferably the method comprises inflating the duct while the output of at least one sensor is below a threshold.

Preferably the method comprises inflating the duct while the strain on the surface of the duct, as measured by at least one strain sensor, is below a threshold.

Preferably the method comprises inflating the duct until the output of at least one sensor is above a threshold.

Preferably the method comprises inflating the duct until the output of at least one sensor falls within a predetermined range.

Preferably the method comprises inflating the duct while the contact pressure between the duct and a cell, as measured by at least one pressure sensor, is outside a predetermined range.

Preferably the method comprises at least partially surrounding at least a part of the duct with a potting means. Advantageously, the potting means is used to reinforce the battery pack and securely hold components therein.

Preferably the method comprises at least partially surrounding at least a part of the duct with a potting means wherein the potting means comprises an expandable foam, polyurethane foam or a silicone potting material.

Preferably the method comprises at least partially surrounding at least a part of the duct with a potting means when the output of at least one sensor is above a threshold.

Preferably the method comprises at least partially surrounding at least a part of the duct with a potting means when the strain on the surface of the duct, as measured by at least one strain sensor, is above a threshold.

Preferably the method comprises at least partially surrounding at least a part of the duct with a potting means when the contact pressure between the duct and a cell, as measured by at least one pressure sensor, is above a threshold.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The invention will now be described with reference to the accompanying drawings which show, by way of example only, one or more preferred embodiments of an apparatus in accordance with the invention.

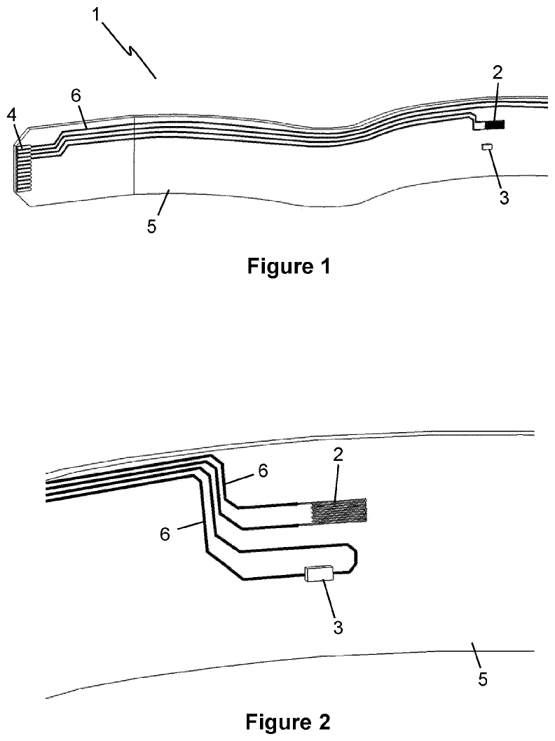

FIG. 1 is a perspective view of a carrier in accordance with the invention.

FIG. 2 is a closeup perspective view of part of the carrier shown in FIG. 1.

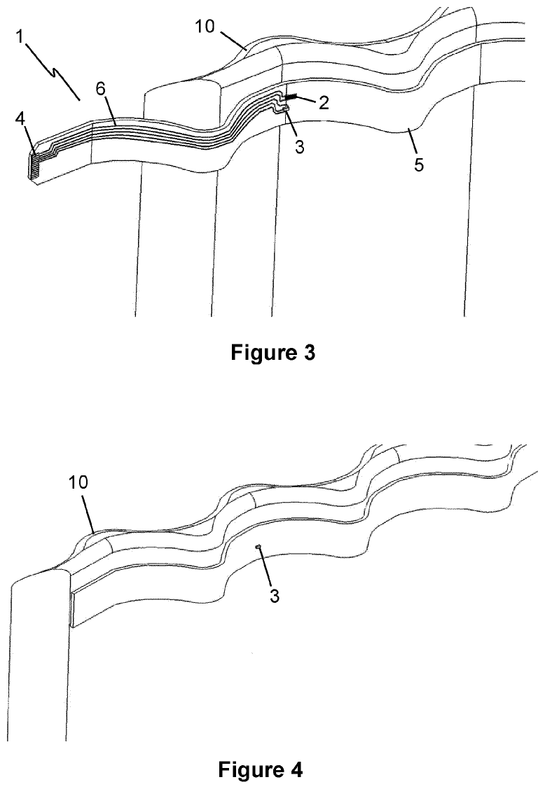

FIG. 3 is a perspective view of a carrier in accordance with the invention attached to a thermal management duct.

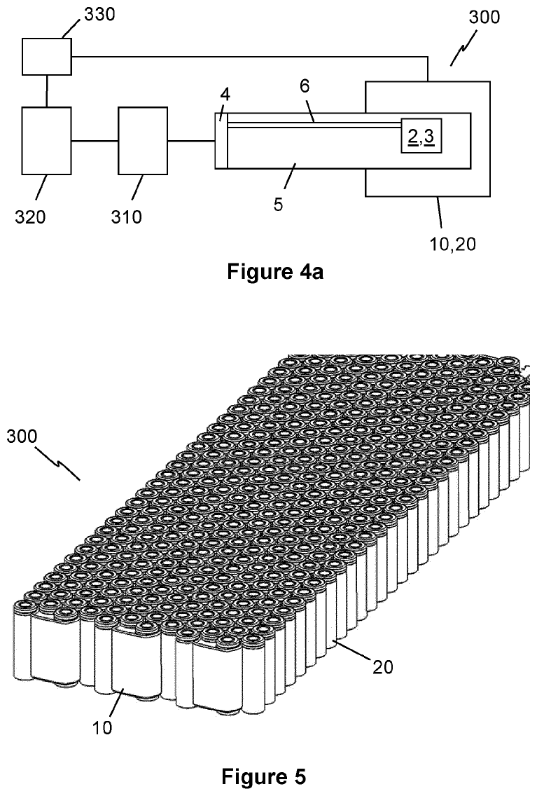

FIG. 4 is an alternative perspective view of the carrier of FIG. 3.

FIG. 4a is a schematic view of a battery pack comprising a carrier connected to a measurement circuit and a control computer.

FIG. 5 is a perspective view of a plurality of cells in thermal contact with a duct comprising a carrier according to an aspect of the invention.

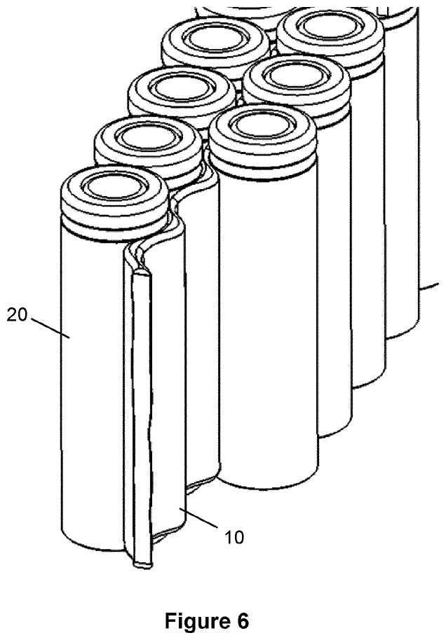

FIG. 6 is a perspective view of a plurality of cells in thermal contact with a duct and carrier.

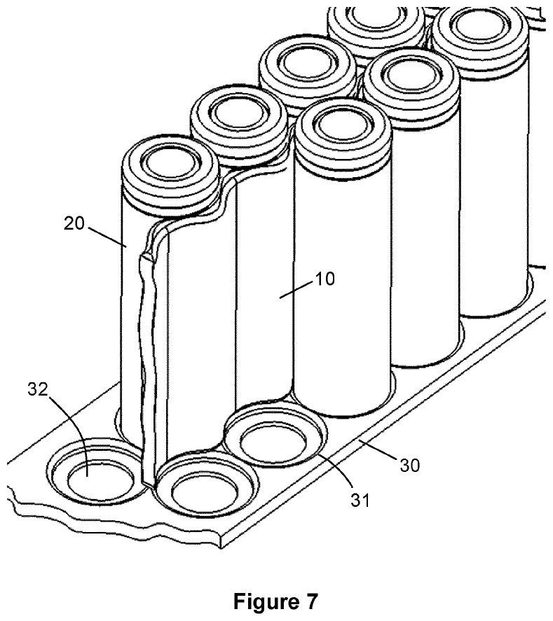

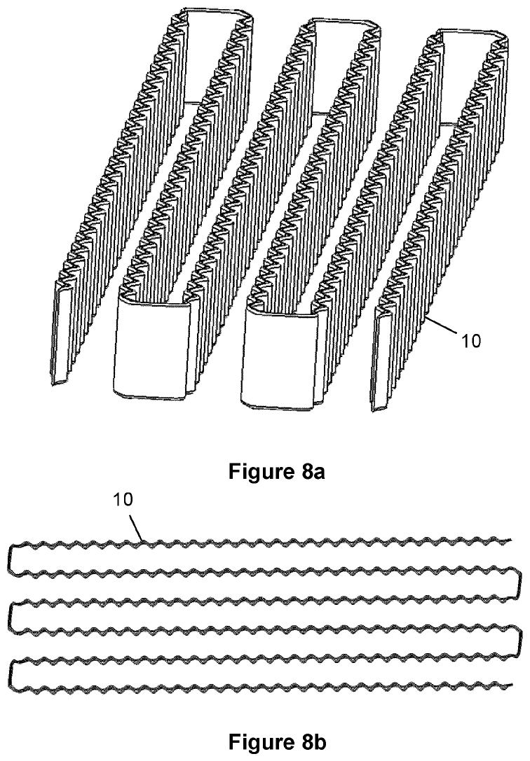

FIG. 7 is a perspective view of a plurality of cells in thermal contact with a duct and carrier and mounted on a base plate.

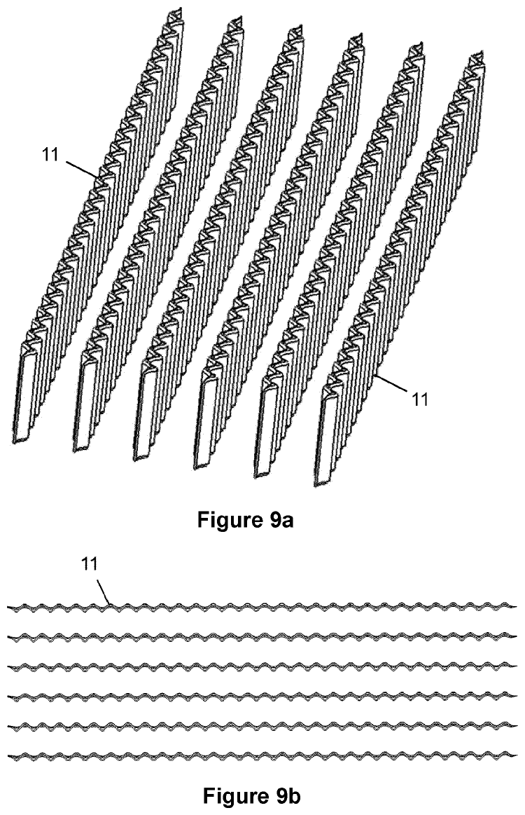

FIG. 8a is a perspective view of a serpentine duct comprising a carrier according to an aspect of the invention.

FIG. 8b is a top view of the serpentine duct shown in FIG. 7a.

FIG. 9a is a perspective view of a manifold duct comprising a heat transfer material according to an aspect of the invention.

FIG. 9b is a top view of the manifold duct shown in FIG. 8a.

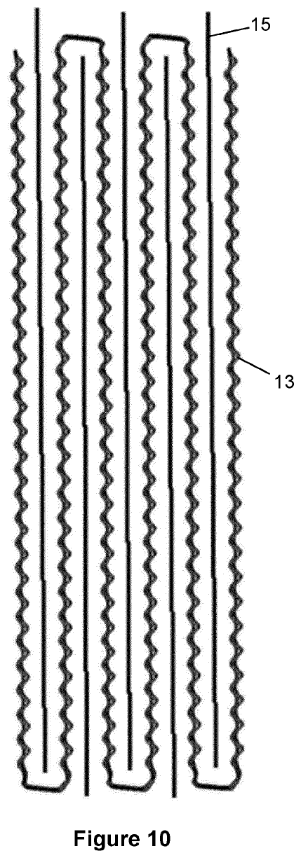

FIG. 10 is a top view of a serpentine duct and a plurality of carriers according to the invention.

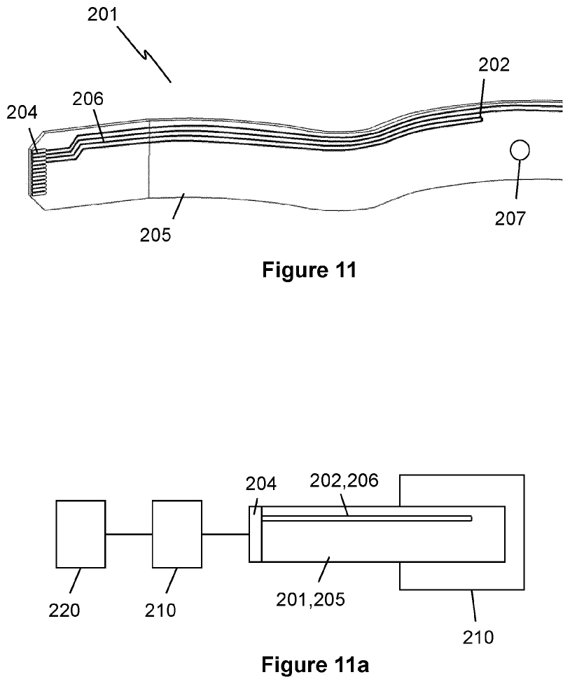

FIG. 11 is a further perspective view of a carrier in accordance with an aspect of the invention.

FIG. 11a is a schematic view of the carrier of FIG. 11 operably connected to a switching arrangement.

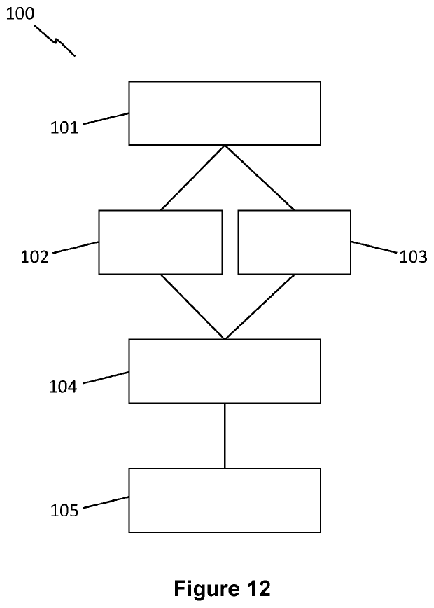

FIG. 12 is a schematic view of a method of manufacturing a battery pack according to an aspect of the invention.

In the FIG. 1 there is shown a carrier indicated generally by the numeral 1. The carrier 1 comprises first and second sensors 2 and 3 which are connected to respective electrical connection pads 4. The carrier 1 comprises a flexible substrate 5 in the form of a flexible printed circuit board (PCB). The flexible substrate 5 comprises a conductive pattern layer between a polyimine base and a polyimine cover layer. The multiple layers of the flexible substrate 5 are attached via an adhesive.

The conductive pattern layer includes a plurality of conductive copper traces 6 that are 0.05-1 mm wide and which provide electrical connections between the sensors 2,3 and respective electrical connection pads 4. The sensors 2,3 can be connected to the electrical connection pads 4 according to any suitable wiring scheme for example using two traces for each sensor. A single ground line or common ground plane may be shared between a number of sensors while each sensor has its own unique signal line.

The electrical connection pads 4 are gold plated, electrically conductive pads that lie above the polyimine cover layer of the flexible substrate 5, allowing electrical connections to be made to the traces in the conductive pattern layer. The electrical connection pads 4 provide a way of connecting the carrier 1 to external components such as a measurement circuit or computer. The electrical connection pads 4 are located proximally to peripheral edge of the carrier 1 for ease of accessibility when installed within a battery pack.

The skilled person will appreciate that any suitable electrical connectors may be provided instead of, or in addition to the electrical connection pads 4. The carrier 1 could include edge connectors, solder pads, board-to-wire connectors, mezzanine connectors, 2-4-8- or 16-pin connectors, surface-mounted pins, connection blocks or terminals.

The sensors 2,3 on carrier 1 are shown in detail in FIG. 2. The first and second sensors 2 and 3 are surface mounted sensors electrically connected to traces 6 in the conductive pattern layer. The first and second sensors 2, 3 are used to measure strain and temperature, respectively.

The sensors 2,3 and the other components such as the connectors can be attached to the carrier 1 using any suitable means, for example using an adhesive such as an epoxy. Alternatively, the sensors and/or connectors may be attached to the carrier 1 using any suitable fixing means such as a conductive epoxy, surface mount technology, hand soldering, TIG welding, laser welding and/or via another component such as a PCB.

FIG. 3 shows the carrier 1 partially attached to a duct 10 on the outer surface of the duct 10. One end of the carrier 1 is not attached to the duct, in particular the peripheral end of the carrier 1 where the connection pads 4 are located, allowing the connection pads 4 to be attached to a measurement circuit or other electrical equipment.

In the preferred embodiment the carrier 1 is heat welded to the duct 10 but in other embodiments the carrier 1 may instead be adhesively attached to the duct 10 using an adhesive such as an epoxy. The surface of the duct 10 and/or the carrier 1 is treated with corona discharge plasma treatment prior to the application of the epoxy, to ensure good adhesion to the epoxy.

In yet further optional embodiments the carrier 1 may be attached to the duct 10 via mechanical fixation. In an example, the carrier 1 includes one or more vias or through holes through which a part of the duct 10 or other fixing member attached to the duct 10 can pass, in order to retain the carrier 1 in position on the duct 10. The duct 10 may be partially melted such that it passes through such a via or through hole in the carrier 1 and ‘mushrooms’ over the edges of the via or through hole to retain the carrier 1 in position on the duct 10. Alternatively, the carrier 1 may be attached to the duct 10 using any suitable fixing means such as using a conductive epoxy, surface mount technology, hand soldering, TIG welding, laser welding and/or via another component such as a PCB.

In the example shown in FIG. 3 the duct is a flexible duct but the carrier 1 may be attached to any duct within a battery pack for example a rigid metallic duct.

The carrier 1 includes a strain sensor 2 which is used to measure strain on the duct 10. The output of the strain sensor 2 provides an indication of the flex and/or extension of the duct 10 while the duct is in an inflated state and can be used to infer the pressure level within the duct. The user of the thermal management system can use this information to avoid over-pressurising/over-inflating the duct and thereby reduce the risk of bursting of the duct 10. In preferred embodiments the strain sensors 2 are resistive foil strain gauges or capacitive strain gauges.

The carrier 1 comprises a plurality of strain sensors 2 for measuring strain on the duct 10 in a number of positions and/or directions. Position-sensitive strain measurements can be used to infer that e.g. a blockage has occurred in the duct 10 if pressure on the inlet side of the duct is higher than pressure on the outlet side of the duct. A plurality of strain sensors 2 along the duct would enable a user to identify the site of the blockage within the duct 10, for example at a bend or corner.

The carrier 1 may include at least one pressure sensor in order to measure the contact pressure between the duct 10 and a cell 20. The pressure sensors can be located between such a cell 20 and the duct 10. Suitable pressure sensors include piezoresistive pressure sensors and/or MEMS pressure sensors. As the duct 20 is inflated, the pressure sensor is pushed against the casing of the cell 20 and the output of the sensor is proportional to the amount of contact pressure. Since the thermal coupling between the duct and the cell partly depends on the level of contact pressure, the pressure sensor can be used to infer the level of thermal coupling between the duct 20 and a cell 20.

The carrier 1 includes a temperature sensor 3 which is used to measure temperature within the pack e.g. the temperature on the surface of at least one cell 20. In use, the temperature sensor 3 is located on the surface of the carrier 1 adjacent to a cell 20. In the inflated state, the duct 10 presses the temperature sensor 3 against the cell to improve the thermal contact therewith.

The carrier 1 includes a thermal barrier portion which is used to limit the thermal coupling between the temperature sensor 3 and the duct 10, the temperature of which is not intended to be measured. The thermal barrier is located between the duct and the temperature sensor 3, on the opposite side of the carrier 1 to the temperature sensor 3. The physical extent of the thermal barrier is substantially equal to the area of the temperature sensor 3.

The carrier 1 may include a plurality of temperature sensors for measuring temperature of the duct, particularly the surface of the duct, and a plurality of temperature sensors each used to measure an individual cell or group of cells within the pack.

Where the carrier 1 includes a plurality of sensors, it is possible to map out physical properties along the duct. For example, it is possible to use multiple strain sensors or multiple temperature sensors of the same type throughout the pack (e.g. multiple strain sensors or multiple temperature sensors). Each sensor may be individually addressable, allowing a control computer to resolve the distribution of measured parameters within the pack. For example, the control computer may be able to identify an individual cell or cell module where there is an elevated temperature within the pack.

As shown in FIG. 4a, one or more measurement circuits 310 (e.g. Wheatstone bridge circuits 310) can be operably coupled to the sensors 2,3 via the electrical connection pads 4. The output of the measurement circuits 310 may be monitored by e.g. a measurement computer 320 and/or the control circuit 330 of the battery pack 300. Alternatively, the measurement computer or control circuit 320 may be directly connected to the one or more sensors 2,3. The measurement computer 320 may be operable to output a signal when the measured value of at least one sensor 2,3 is above a threshold, below a threshold and/or within a predetermined range. For example, the measurement computer may be operable to output a signal when the value of one or more temperature sensors (e.g. temperature sensors which monitor the temperature of a cell) is above a threshold. The measurement computer 320 may be operable to output a signal when the value of one or more strain sensors (e.g. a strain sensor which is used to infer the pressure within the duct 10) is below a threshold.

The operation of the battery pack 300 can based on the output of the sensors on carrier 1. For example, a control circuit 330 of the battery pack may be operable to cause the pressure within the duct 10 to be increased when the pressure, as by the one or more strain sensors, falls below a threshold. The control circuit 330 may then cause the pressure within the duct to increase. Alternatively or additionally, the control circuit 330 can be operable to cause the pressure within the duct 10 to increase or decrease when the contact pressure between the duct 10 and one or more cells 20, as measured by the one or more pressure sensors, falls outside a predetermined range. The control circuit may cause the flowrate of thermal management fluid within the duct to increase when e.g. the temperature of one or more cells, as measured by the one or more temperature sensors, is greater than a threshold.

As shown in FIG. 5, the duct 10 is a serpentine thermal management duct located within a battery pack among an array of cylindrical cells 20. The duct 10 is used to thermally manage the cells 20. In use, the carrier 1 retains and locates sensors 2,3 within the battery pack in suitable positions adjacent to the cells 20 and/or duct 10.

The duct 10 contains a thermal management fluid such as air, water or a water-glycol mixture which is used to transfer heat to or from the cells 20 (not shown). In use, the duct is operably connected to a thermal management system comprising a reservoir containing thermal management fluid, a coolant loop, a pump and a heat exchanger. The thermal management system may be pressurised by running a pressurisation cycle wherein thermal management fluid from the reservoir is drawn into the coolant loop to increase the pressure in the coolant loop and duct 10.

In embodiments wherein the duct 10 is an inflatable, flexible duct, pressure of the thermal management fluid in the duct 10 causes the flexible duct to expand. As the flexible duct 10 expands, it conforms to the undulating surface presented by the shape of the cylindrical cells 20 thereby increasing the surface area of the flexible duct that is in contact with each of the cylindrical cells 20. This is advantageous as it increases the thermal contact area and contact pressure between the cells 20 and the flexible duct, improving the transfer of thermal energy between the flexible duct and the individual cells. Further advantageously, as the duct 10 pushes against the walls of the cells 20 so too is the carrier. The force of the duct 10 can increase the contact pressure, and therefore coupling, between sensors mounted on the carrier 1 and the cells 20.

The duct 10 can be formed from an inflatable plastics or polymer-based material. An inflatable plastics or polymer-based material is advantageous as the material is intrinsically electrically insulating, lightweight and does not corrode or chemically interact with a thermal management fluid such as a glycol water mix. Preferably the inflatable plastics or polymer-based material is polyester, low-density polyethylene (LDPE), linear low-density polyethylene (LLDPE) or high-density polyethylene (HDPE). The walls of the flexible duct 10 are between 10 μm and 150 μm thick, providing good thermal transfer properties between the or each duct and the cells. In embodiments where the duct 10 is rigid, it is formed from a metal such as aluminium or copper which provides good thermal conduction between the duct and the cells.

The carrier 1 may include one or more extra sensors at certain positions in order to provide a more finely-grained measurement of the duct and/or cells at certain locations within the pack. For example, in regions where the duct 10 passes around a bend (e.g. in a serpentine duct) the carrier 1 may include extra strain sensors in order to detect possible collapse and/or kinking of the duct 10. In another example the carrier 1 may include an increased level of temperature sensors in regions where there is an elevated risk of high temperature within the pack.

The duct 10 can be a single-lumen duct or, when used in large battery packs where a single lumen duct is not capable of promoting an even temperature distribution, the duct 10 may be a multi-lumen duct. A multi-lumen duct comprises two or more lumens along which thermal management fluid is able to flow.

FIGS. 6 and 7 show that the duct 10 extends in a longitudinal direction which is generally perpendicular to the major axis of the cells 20. The major axis of the carrier 1 (not shown) lies in a direction parallel to the direction of the duct 10. The carrier 1 (not shown) is located on the surface of the duct 10 between the duct 10 and the cells 20. The duct 10 is in thermal contact with the cells to allow heat to be transferred between the cells and duct for the purpose of heating and/or cooling the cells 20. The carrier 1 (not shown) extends along a portion of the height of the duct/sidewall of the cells.

The carrier 1 is elongate, 10 mm wide and 0.1 mm thick. In optional embodiments the carrier 1 may be 2-20 mm or 5-10 mm wide and have any appropriate thickness which provides appropriate flexibility, for example in the range 0.01-1 mm. Where the cells 20 are 18650 or 2170 cells, the height of the duct (when in use) is substantially equal to, or slightly less than, the full height of a cell 20. The carrier 1 only covers a portion of the height of the duct 10 and is therefore only in contact with a portion of the sidewall(s) of the cell(s).

FIG. 7 shows the lower clamshell 30 which is used to locate and retain cells 20. The lower clamshell includes recesses 31 for holding cells in a close-packed configuration and apertures 32 for making electrical connections between cells on one side of the lower clamshell 30 and busbars on the opposite side of the clamshell (i.e. on the exterior of the pack). The battery pack, once fully constructed, includes an upper clamshell (similar to the lower clamshell 30) and sidewalls which connect the upper and lower clamshells at the peripheral edges of the array of cells 20.

FIGS. 8a-9b show possible configurations for the duct 10. FIGS. 8a and 8b show the duct in a serpentine configuration comprising generally straight sections connected by corner sections. FIG. 8a shows a plurality of parallel straight ducts 11.

In an alternative embodiment shown in FIG. 9, the battery pack includes at least one measurement duct 15 which is formed of an inflatable tube and a carrier 1 attached to the surface thereof. The measurement duct 15 is placed between rows of cells and filled with an expandable foam such as a polyurethane or intumescent foam. As the foam expands the duct 1 conforms to the surface shape of the cells 10. Expansion of the duct 15 causes the carrier 1 to be pushed against the surface of the cells. Where the carrier 1 includes e.g. a temperature sensor the sensor is pushed against the sidewall of a cell to ensure good thermal contact between the sensor and surface of the cell.

In the example of FIG. 9 measurement ducts 15 are located between every other row of cells and a serpentine thermal management duct 13 is located between cells in rows not including a measurement duct 15 (i.e. every other row of cells).

FIG. 11 shows a further carrier indicated generally by the numeral 201. The carrier 201 is generally similar to the first embodiment, the difference being that the carrier 201 comprises a conductive trace 206 in the form of a balancing resistor 202 which is connected to respective electrical connection pads 204. The carrier 200 comprises a flexible substrate 205 in the form of a flexible printed circuit board (PCB). The flexible substrate 205 comprises a conductive pattern layer between a polyimine base and a polyimine cover layer. The multiple layers of the flexible substrate 205 are attached via an adhesive. The carrier 205 includes one or more vias or through holes 207 through which a part of a duct 210 or other fixing member attached to a duct 210 can pass, in order to retain the carrier 205 in position on the duct 210.

The carrier 200 comprises an energy dissipating arrangement used to dissipate energy from one or more cells 220. The energy dissipating arrangement is used to dissipate energy from one or more cells 220 for the purpose of cell balancing within the pack. The energy dissipating arrangement includes at least one cell balancing resistor 202 in the form of a conductive copper trace 206 in a conductive pattern layer of the carrier 200. The conductive trace 206 used as a balancing resistor is 0.05-0.2 mm wide, 0.1-0.2 mm thick and 100-10000 mm long and follows a labyrinth path comprising a plurality of straight sections connected by bends/corners. In alternatives the cell balancing resistor may be a surface mounted resistor located on the carrier 1. The balancing resistor has a resistance of 1-100Ω, in some cases approximately 10Ω.

As shown in FIG. 11a, the cell balancing resistor 202 is operably connected to a switching arrangement 210 which is operable, when switched, to cause current to flow from one or more cells 220 having a high voltage through the balancing resistor 220. The switching arrangement 210 can comprise one or more solid-state switches such as transistors 210. The switching arrangement 210 can be connected directly to the carrier 205 or be part of the control circuitry.

Passing current from a cell 220 through the balancing resistor 202 dissipates energy within the cell and has the effect of lowering the cell voltage. Energy from the cell 220 is dissipated in the resistor 202 until the voltage of the cell is substantially equal to the voltage of the other cells within the pack. The cell balancing resistor is in thermal contact with the duct 210 so that any heat that is generated by the resistor 202 is transferred to the thermal management fluid within the duct 210, preventing excessive heating of the balancing resistor 202.

FIG. 12 shows a method 100 of manufacturing a battery pack comprising one or more cells and at least one flexible duct. The method 100 comprises operably coupling one or more sensors to the duct (step 101), inflating the duct (step 102) and monitoring the output of the sensor (step 103). The sensor coupled to the duct can be a strain sensor, temperature sensor or pressure sensor. The method may include monitoring a plurality of sensors coupled to the duct in step 103.

In step 101 one or more sensors are coupled to the duct. Attachment can be via adhesion or heat welding a carrier 1 to the duct 10 as described above. The duct can be any suitable duct such as a flexible serpentine or straight duct as outlined above and shown in e.g. FIGS. 3-10.

In step 102, the duct is located adjacent to or between one or more cells in a battery pack while it is being inflated. A thermal management fluid such as air, water or a water-glycol mixture is used to inflate the duct. In alternatives, the duct is inflated using an expandable foam which is inserted into the duct in a liquid state.

In step 103 sensors are used to measure the duct. Ideally, steps 102 and 103 are carried out simultaneously so that the sensor measurements inform the correct inflation of the duct. In the case where the sensor is a strain sensor, in step 103 the strain on the duct is measured during inflation. Step 103 may also include measuring contact pressure between the duct and a cell during inflation of the duct using a pressure sensor.

The method 100 comprises inflating the duct while the output of at least one sensor is below a threshold. For example, the method 100 comprises inflating the duct while the strain on the surface of the duct, as measured by at least one strain sensor, is below a threshold or while the contact pressure between the duct and a cell, as measured by at least one pressure sensor, is below a threshold. The duct is inflated until the output of at least one sensor falls within a predetermined range.

The method 100 comprises inflating the duct until the output of at least one sensor is above a threshold. For example, the duct is inflated while it is above a temperature threshold of e.g. 15° C. This ensures that the duct is sufficiently flexible—at low temperatures the duct will be more difficult to expand.

Once the duct has been sufficiently inflated, the method 100 comprises, in step 104, at least partially surrounding the duct with a potting material. Surrounding at least a part of the duct with the potting means in step 104 is carried out when the output of at least one sensor is above a threshold e.g. when the strain on the surface of the duct, as measured by at least one strain sensor, is above a threshold. Alternatively or additionally surrounding at least a part of the duct with the potting means in step 104 may be carried out when the contact pressure between the duct and a cell, as measured by at least one pressure sensor, is above a threshold.

In preferred embodiments when the duct is sufficiently inflated, an expandable potting material such as polyurethane or intumescent foam is poured into the pack and surrounds the duct while it expands. The potting material can be any suitable potting material such as an epoxy or an expandable foam such as intumescent polyurethane foam.

In step 105 the potting material is cured or hardened. The output of at least one sensor may be continually monitored while the potting material is poured into the pack and during expansion or curing of the potting material.

As will be understood by the skilled person, the example embodiments presented above can be modified in a number of ways without departing from the scope of the invention. For example, the substrate 6 can comprise any suitable flexible material for example a polyimide film, a polyester (PET) film, a glass fiber epoxy laminate or FR-4 and/or include a reinforcement member such as a piece of polyimide, FR-1, FR-2, FR-4, CEM-1, CEM-3, RO3000 or RO4000. The reinforcement member may be located at the position of e.g. the electrical connection pads 4 in order to give added strength of the carrier 1 at this position.

The skilled person will appreciate that any suitable sensors can be incorporated into the carrier 1. Suitable sensors include any combination of temperature sensors, strain sensors, pressure sensors, volatile organic compound (VOC) sensors, carbon monoxide (CO) sensors, carbon dioxide (CO₂) sensors, smoke sensors, leak detectors, acceleration sensors, microelectromechanical systems (MEMS) sensors, state of health (SoH) sensors or state of charge (SoC) sensors. Leak sensors for example can be used to measuring leakage of thermal management fluid from the duct within the battery pack.

The sensors may be arranged in any suitable array or pattern on the carrier and may be irregularly- or regularly-spaced along the length of the carrier 1, for example in an equally spaced configuration. The distance between similar sensors (e.g. temperature sensors) may be substantially equal to the distance between cells in the pack along the direction of the duct.

The carrier 1 can be employed in any suitable battery pack for example a battery pack comprising one or more prismatic cells or cylindrical cells of 18650 or 2170 size. The battery pack may be used in any hybrid or electric vehicle.

While the foregoing description of the invention has described the use of electrical communication techniques to interrogate sensors, the skilled person will appreciate that any suitable communication technique, such as optical communication methods, can be used. For example, the carrier could include a plurality of optical fibres which are used to interrogate sensors such as fiber Bragg grating temperature or strain sensors located adjacent to one or more cells or ducts within a battery pack.

In the preceding discussion of the invention, unless stated to the contrary, the disclosure of alternative values for the upper or lower limit of the permitted range of a parameter, coupled with an indication that one of the values is more highly preferred than the other, is to be construed as an implied statement that each intermediate value of the parameter, lying between the more preferred and the less preferred of the alternatives, is itself preferred to the less preferred value and also to each value lying between the less preferred value and the intermediate value.

The features disclosed in the foregoing description or the following drawings, expressed in their specific forms or in terms of a means for performing a disclosed function, or a method or a process of attaining the disclosed result, as appropriate, may separately, or in any combination of such features be utilised for realising the invention in diverse forms thereof.

1. A carrier means for retaining and locating one or more electrical elements within a battery pack, the battery pack comprising one or more cells and a thermal management duct in thermal contact with at least one cell, the carrier means comprising at least one electrical element for performing at least one battery pack function and a connection means for providing a communicative connection to the carrier means, wherein the electrical element is operably connected to the connection means.

2. A carrier means according to claim 1 wherein the carrier means comprises an electrical element in the form of at least one sensing means for sensing one or more conditions of the battery pack.

3. A carrier means according to claim 2 wherein the sensing means comprises one or more sensors.

4. A carrier means according to claim 3 wherein the sensing means comprises more than one type of sensor.

5. A carrier means according to claim 3 or claim 4 wherein the sensing means comprises an array of sensors.

6. A carrier means according to any one of claims 2-5 wherein the sensing means comprises one or more strain sensors for measuring strain on the duct.

7. A carrier means according to any claim 6 wherein the sensing means comprises a plurality of strain sensors for measuring strain on the duct in a number of positions and/or directions.

8. A carrier means according to any one of claims 2-7 wherein the sensing means comprises one or more pressure sensors for measuring contact pressure between the duct and at least one cell.

9. A carrier means according to claim 8 wherein the sensing means comprises a plurality of pressure sensors for measuring contact pressure between the duct and a plurality of cells along the length of the duct.

10. A carrier means according to any one of claims 2-9 wherein the sensing means comprises one or more temperature sensors for measuring the temperature of at least one cell.

11. A carrier means according to claim 10 wherein the sensing means comprises a plurality of temperature sensors for measuring the temperature of a plurality of cells.

12. A carrier means according to claim 10 or claim 11 wherein the carrier means comprises a thermal barrier means locatable between at least one temperature sensor and the duct.

13. A carrier means according to any preceding claim wherein the carrier means comprises an electrical element in the form of at least one energy dissipating means for dissipating energy from one or more cells.

14. A carrier means according to claim 13 wherein the energy dissipating means comprises a cell balancing means comprising one or more balancing resistors.

15. A carrier means according to claim 14 wherein the or each balancing resistor is a conductive trace within the conductive pattern layer.

16. A carrier means according to claim 15 wherein the or each conductive trace follows a path comprising one or more straight sections and one or more bends or corners.

17. A carrier means according to any one of claims 14 to 16 wherein the energy dissipating means is operably connected to a switching means via the connection means, wherein the switching means is used to control discharge of energy from a cell through the one or more balancing resistors.

18. A carrier means according to any preceding claim wherein the carrier means is adapted for operable connection to the thermal management duct.

19. A carrier means according to claim 18 wherein the carrier means is adapted for thermal and/or mechanical connection to the thermal management duct.

20. A carrier means according to any preceding claim wherein the carrier means is attached to a thermal management duct along at least a portion of the length of the carrier means.

21. A carrier means according to claim 20 wherein the carrier means is locatable between the outer surface of the duct and one or more cells.

22. A carrier means according to any preceding claim wherein the duct is inflatable.

23. A carrier means according to claim 22 wherein the duct is conformable such that, in the inflated state, the duct at least partially conforms to at least part of the surface of one or more cells.

24. A carrier means according to claim 22 or 23 wherein the duct is formed from a polymer-based material.

25. A carrier means according to claim 24 wherein the duct is formed from an inflatable plastics material.

26. A carrier means according to claim 25 wherein the inflatable plastics material is polyester, low-density polyethylene (LDPE), linear low-density polyethylene (LLDPE) or high-density polyethylene (HDPE).

27. A carrier means according to any one of claims 22-26 wherein the duct is filled with expandable foam such as intumescent or polyurethane foam.

28. A carrier means according to any preceding claim wherein the carrier means is flexible.

29. A carrier means according to claim 28 wherein the carrier means comprises a flexible substrate.

30. A carrier means according to claim 28 or claim 29 wherein the carrier means is a flexible printed circuit board.

31. A carrier means according to any preceding claim wherein the substrate comprises at least one conductive pattern layer.

32. A carrier means according to claim 31 wherein the electrical element is electrically connected to the connection means via conductive traces in the conductive pattern layer.

33. A carrier means according to claim 31 or claim 32 wherein the conductive traces include one or more signal lines and at least one ground line.

34. A carrier means according to any preceding claim wherein the connection means is located proximal to a peripheral edge of the carrier means.

35. A method of manufacturing a battery pack comprising one or more cells, at least one flexible duct and a carrier means according to any preceding claim, the method comprising operably coupling the carrier means to the duct, inflating the duct and monitoring the output of the sensing means.

36. A method of manufacturing a battery pack according to claim 35, wherein the method further comprises inflating the duct when the duct is located adjacent to or between one or more cells.

37. A method of manufacturing a battery pack according to claim 35 or claim 36, wherein the method further comprises inflating the duct until the output of at least one sensor falls within a predetermined range.

38. A method of manufacturing a battery pack according to any one of claims 35 to 37, wherein the method further comprises at least partially surrounding at least a part of the duct with a potting means when the strain on the surface of the duct, as measured by at least one strain sensor, is above a threshold, the potting means comprising an expandable foam, polyurethane foam or a silicone potting material.
